(19) United States
(12) Patent Application Publication
(10) Pub. No.: US 2026/0285395 A1
(43) Pub. Date: Sep. 24, 2026

(54) CORNER MODULE AND VEHICLE INCLUDING THE SAME

(71) Applicant: ELECTRONICS AND TELECOMMUNICATIONS RESEARCH INSTITUTE, Daejeon (KR)

(72) Inventors: Hanul JUNG, Daejeon (KR); Junghyun CHOI, Daejeon (KR); Laekyoung LEE, Daejeon (KR)

(21) Appl. No.: 19/458,584

(22) Filed: Jan. 23, 2026

(30) Foreign Application Priority Data
Jan. 24, 2025 (KR) 10-2025-0011482
Apr. 17, 2025 (KR) 10-2025-0050380

(51) Int. Cl. B62D 5/04; B60G 7/00; B60G 7/02

(52) U.S. Cl. CPC B62D 5/0418; B60G 7/001; B60G 7/02; B62D 5/0442

(57) ABSTRACT

A corner module includes: a main body; a wheel spaced apart from the main body; a drive unit connected to the wheel and configured to provide a driving force to the wheel; a first link arm disposed between the main body and the drive unit; a steering motor disposed inside the first link arm; and a steering unit connected to the steering motor and configured to rotate the wheel about a steering axis.

### CROSS-REFERENCE TO RELATED APPLICATION

This application claims priority under 35 U.S.C § 119 to Korean Patent Application No. 10-2025-0011482 filed in the Korean Intellectual Property Office on Jan. 24, 2025, and Korean Patent Application No. 10-2025-0050380 filed in the Korean Intellectual Property Office on Apr. 17, 2025, the entire contents of which are hereby incorporated by reference.

### TECHNICAL FIELD

The present disclosure relates to a corner module and a vehicle including the same, and more particularly, to a corner module in which a driving device, a steering device, and a suspension device are integrated, and a vehicle including the same.

### BACKGROUND

Recently, new-concept mobility is being developed, mainly by global automotive parts companies. In particular, vehicles are being developed that use an integrated corner module in which steering, suspension, driving, and braking devices are integrated to implement various driving modes.

Such a vehicle may enable various driving modes compared to conventional automobiles and has an advantage of allowing various vehicles to be manufactured according to consumer needs.

However, a vehicle to which a corner module is applied has a disadvantage in that it is mechanically very complex because existing chassis structures are integrated into a single module, it is difficult to secure a high payload, and it is subject to spatial constraints.

The background art of the present disclosure is disclosed in Korean Patent Application Publication No. 10-2019-0041855 (published on Apr. 23, 2019, entitled “Steering System for In-wheel Motor Vehicle”).

### SUMMARY

An object of an embodiment is to provide a corner module that allows for efficient space utilization and weight reduction, and a vehicle including the same.

In accordance with a first embodiment of the present disclosure, there is provided a corner module including: a main body; a wheel spaced apart from the main body; a drive unit connected to the wheel and configured to provide a driving force to the wheel; a first link arm disposed between the main body and the drive unit; a steering motor disposed inside the first link arm; and a steering unit connected to the steering motor and configured to rotate the wheel about a steering axis.

The first link arm may include: a first outer arm having a first outer end rotatably connected to the drive unit and a first outer connecting part spaced apart from the first outer end; and a first inner arm having a first inner connecting part rotatably connected to the first outer connecting part and a first inner end rotatably connected to the main body, wherein the steering motor may be disposed inside the first inner arm.

A rotation axis of the first outer end may be disposed to be inclined with respect to the steering axis.

A rotation axis of the first inner connecting part may intersect a rotation axis of the first outer end, and an intersection point of the rotation axis of the first outer end and the rotation axis of the first inner connecting part may be disposed on the steering axis.

The steering unit may include: a first steering unit connected to the steering motor and the drive unit and configured to rotate the drive unit with respect to the first outer arm; and a second steering unit connected to the steering motor and the first inner arm and configured to rotate the first inner arm with respect to the main body.

The first steering unit may include: a steering shaft connected to the steering motor; a first steering transmission member connected to the steering shaft and rotating together with the steering shaft; and a second steering transmission member connected to the drive unit and the first steering transmission member, wherein the second steering transmission member receives rotational force from the first steering transmission member and is rotated to rotate the drive unit.

A rotation axis of the steering shaft and a rotation axis of the first steering transmission member may be disposed to intersect each other, and the first steering unit may further include an outer universal joint disposed between the steering shaft and the first steering transmission member.

A rotation axis of the second steering transmission member may be disposed to be inclined with respect to the steering axis.

A rotation axis of the second steering transmission member may be parallel to a rotation axis of the first outer end.

A rotation axis of the first steering transmission member and a rotation axis of the second steering transmission member may be disposed to intersect each other.

The second steering transmission member may include a bevel gear.

The second steering unit may include: an arm shaft connected to the steering motor; a first arm transmission member connected to the arm shaft and rotating together with the arm shaft; and a second arm transmission member connected to the first arm transmission member and the first inner end, wherein the second arm transmission member rotates in association with rotation of the first arm transmission member and rotates the first inner end portion.

A rotation axis of the arm shaft and a rotation axis of the first arm transmission member may be disposed to intersect each other, and the second steering unit may further include an inner universal joint disposed between the arm shaft and the first arm transmission member.

A rotation axis of the first arm transmission member may be parallel to a rotation axis of the first inner end, and the first inner end may rotate in a direction opposite to the first arm transmission member.

A rotation axis of the steering shaft and a rotation axis of the arm shaft may be disposed coaxially, and the steering shaft and the arm shaft may extend in opposite directions from the steering motor.

The corner module may further include: a second link arm disposed between the main body and the drive unit, and spaced apart from the first link arm, wherein the second link arm may include: a second outer arm having a second outer end rotatably connected to the drive unit and a second outer connecting part spaced apart from the second outer end; and a second inner arm having a second inner connecting part rotatably connected to the second outer connecting part and a second inner end connected to the main body.

An intersection point of a rotation axis of the second outer end and a rotation axis of the second inner connecting part may be disposed on the steering axis.

A rotation axis of the first inner end and a rotation axis of the second inner end may be parallel to each other.

The main body may include: a first body; a second body movably connected to the first body and supporting the first link arm; and a shock absorber disposed between the first body and the second body.

In accordance with a second embodiment of the present disclosure, there is provided a vehicle, including: a vehicle body; and a plurality of corner modules disposed on a lower side of the vehicle body, wherein the corner module comprises: a main body connected to the vehicle body; a wheel spaced apart from the main body; a drive unit connected to the wheel and configured to provide a driving force to the wheel; a first link arm disposed between the main body and the drive unit; a steering motor disposed inside the first link arm; and a steering unit connected to the steering motor and the drive unit and configured to rotate the wheel about a steering axis.

According to an embodiment of the present disclosure, since steering, driving, and suspension functions are independently performed by each corner module, the operability and stability of the vehicle are improved, and application to small mobility vehicles is facilitated.
According to the embodiment of the present disclosure, as the steering motor and steering unit for the steering operation of the wheel are disposed inside the first link arm, the overall volume of the corner module may be reduced, and damage to the steering system due to interference with external components may be prevented.
According to the embodiment of the present disclosure, by implementing the rotational motion of the first link arm and the second link arm simultaneously with the steering operation of the wheel, the steering angle of the wheel may be further increased within a limited space.

### BRIEF DESCRIPTION OF THE DRAWINGS

FIG. 1 is a perspective view schematically illustrating a configuration of a vehicle according to an embodiment of the present disclosure.

FIG. 2 is a perspective view schematically illustrating a configuration of a corner module according to the embodiment of the present disclosure.

FIG. 3 is a perspective view illustrating the configuration of the corner module according to the embodiment of the present disclosure from a different viewpoint than FIG. 2.

FIG. 4 is a side view schematically illustrating the configuration of the corner module according to the embodiment of the present disclosure.

FIG. 5 is a plan view schematically illustrating the configuration of the corner module according to the embodiment of the present disclosure.

FIG. 6 is a perspective view schematically illustrating a configuration of a steering unit according to the embodiment of the present disclosure.

FIG. 7 is a side view schematically illustrating the configuration of the steering unit according to the embodiment of the present disclosure.

FIG. 8 is an enlarged view schematically illustrating a configuration of a first steering unit according to the embodiment of the present disclosure.

FIG. 9 is an enlarged view schematically illustrating a configuration of a second steering unit according to the embodiment of the present disclosure.

FIG. 10 is a side view schematically illustrating a configuration of a first arm transmission member and a second arm transmission member according to the embodiment of the present disclosure.

FIG. 11 is an enlarged view schematically illustrating a configuration of a second link arm according to the embodiment of the present disclosure.

FIG. 12 to FIG. 15 are diagrams schematically illustrating an operating state of a corner module device according to the embodiment of the present disclosure.

### DETAILED DESCRIPTION

Hereinafter, an embodiment of the present disclosure will be described with reference to the accompanying drawings.

In this process, the thicknesses of lines or the sizes of components illustrated in the drawings may be exaggerated for clarity and convenience of description. In addition, the terms to be described below are defined in consideration of the functions in the present invention, and may vary according to the intention of a user or operator, or custom. Therefore, the definition of these terms should be made based on the contents throughout this specification.

Furthermore, in the present specification, when a part is referred to as being “connected (or coupled)” to another part, this includes not only cases where they are “directly connected (or coupled)” but also cases where they are “indirectly connected (or coupled)” with another member interposed therebetween. In the present specification, when a part is referred to as “including (or comprising)” a component, this means that it may further “include (or comprise)” other components unless specifically stated otherwise.

Furthermore, throughout the specification, the same reference numerals may refer to the same components. Even if the same reference numerals or similar reference numerals are not mentioned or described in a specific drawing, they may be described based on other drawings. Furthermore, even if a part is not indicated by a reference numeral in a specific drawing, the part may be described based on other drawings. Furthermore, the number, shape, size, and relative difference in size of the detailed components included in the drawings of the present application are set for convenience of understanding, and do not limit the embodiments and may be embodied in various forms.

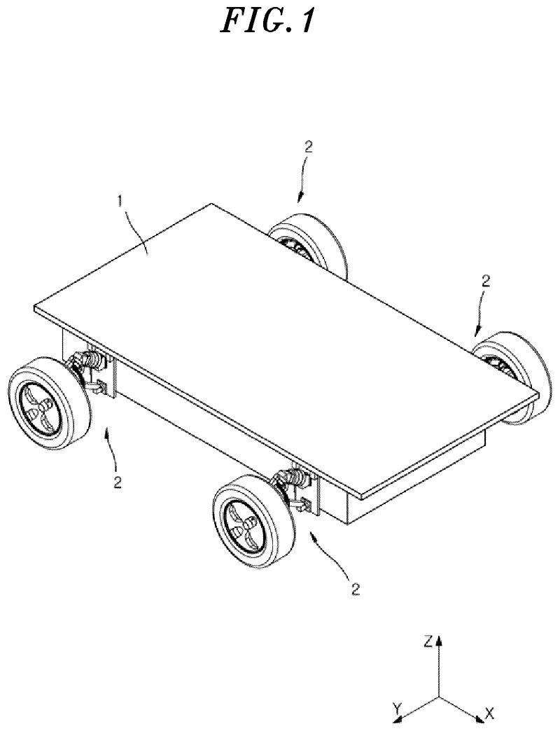

FIG. 1 is a perspective view schematically illustrating a configuration of a vehicle according to an embodiment of the present disclosure.

Referring to FIG. 1, the vehicle according to the embodiment includes a vehicle body 1 and a corner module 2.

The vehicle body 1 may be exemplified as various types of structures that form the framework of the vehicle, such as a chassis frame or a sub-frame. Although FIG. 1 illustrates an example in which the vehicle body 1 has a rectangular frame shape, the shape of the vehicle body 1 is not limited thereto, and the design may be changed in various forms.

The corner module 2 may be disposed on a lower side of the vehicle body 1. The corner module 2 is connected to the vehicle body 1 and may generally perform operations such as driving, braking, steering, and suspension of the vehicle.

A plurality of corner modules 2 may be provided. The plurality of corner modules 2 may be individually connected to different positions of the vehicle body 1. The plurality of corner modules 2 may be disposed in two or more rows along at least one of a length direction and a width direction of the vehicle body 1. Although FIG. 1 illustrates an example in which four corner modules 2 are provided, and each of the corner modules 2 is disposed in two rows along the length direction and the width direction of the vehicle body 1, the arrangement form of the corner modules 2 is not limited thereto, and the design may be changed in various forms.

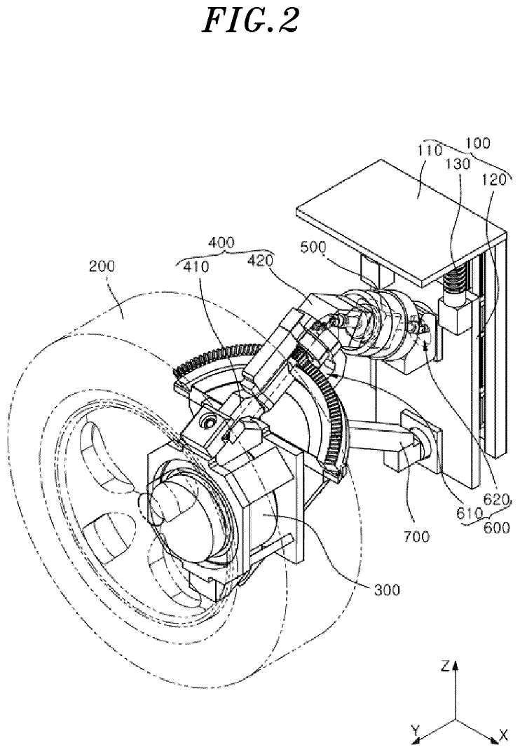

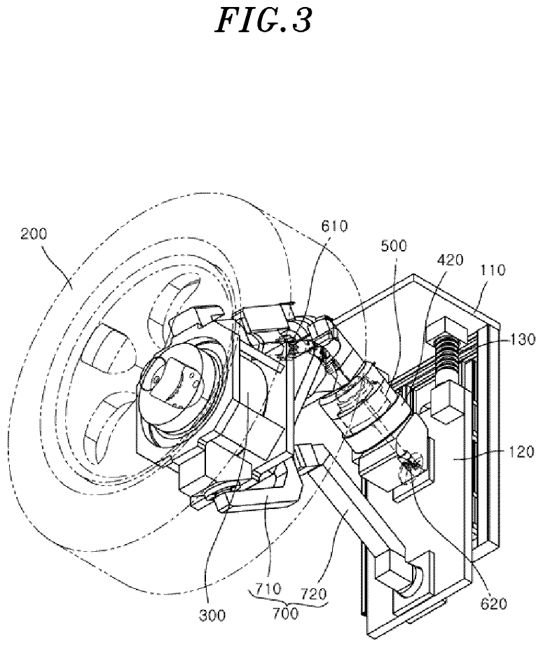

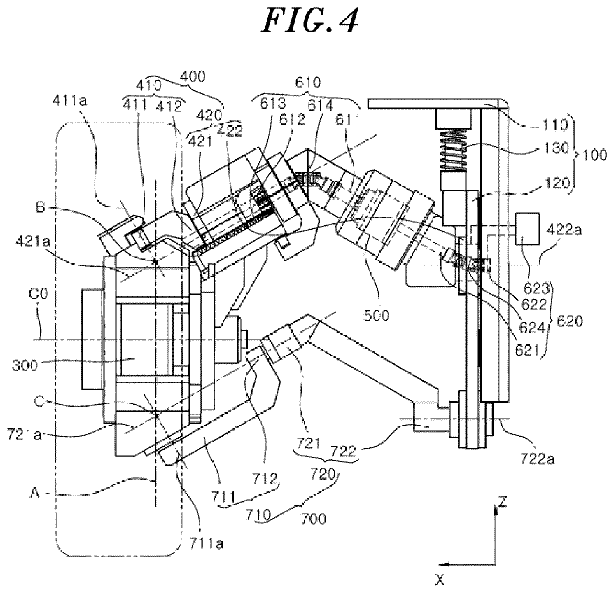

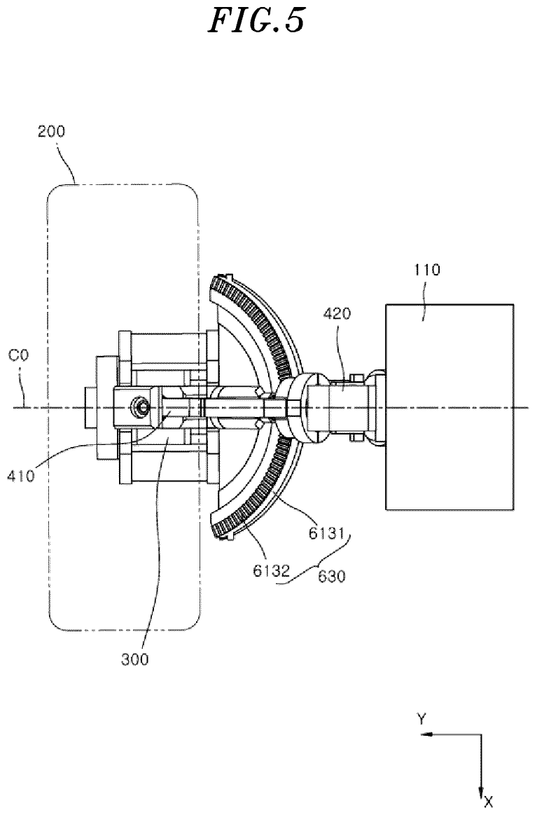

FIG. 2 is a perspective view schematically illustrating a configuration of a corner module according to the embodiment of the present disclosure, FIG. 3 is a perspective view illustrating the configuration of the corner module according to the embodiment of the present disclosure from a different viewpoint than FIG. 2, FIG. 4 is a side view schematically illustrating the configuration of the corner module according to the embodiment of the present disclosure, and FIG. 5 is a plan view schematically illustrating the configuration of the corner module according the embodiment of the present disclosure.

Referring to FIG. 1 to FIG. 5, the corner module 2 according to the embodiment includes a main body 100, a wheel 200, a drive unit 300, a first link arm 400, a steering motor 500, and a steering unit 600.

The main body 100 is connected to the vehicle body 1 and may integrally support the wheel 200, the drive unit 300, the first link arm 400, the steering motor 500, and the steering unit 600.

The main body 100 according to the embodiment may include a first body 110, a second body 120, and a shock absorber 130.

The first body 110 forms one side of the exterior of the main body 100 and may be connected to the vehicle body 1.

The first body 110 according to the embodiment may be disposed on a lower side of the vehicle body 1. An outer surface of the first body 110 may be coupled to the vehicle body 1. The first body 110 may be fixed to the vehicle body 1 by various types of coupling methods such as welding, bolting, adhesion, or fitting.

The specific shape of the first body 110 is not limited to the shape illustrated in FIG. 2 to FIG. 5, and the design may be changed in various forms connectable to the vehicle body 1 according to the shape of the vehicle body 1.

The second body 120 forms the other side of the exterior of the main body 100, which will be described below, and may support a first link arm 400, which will be described below.

The second body 120 according to the embodiment may be disposed to face an outer surface of the first body 110 located on a side opposite the vehicle body 1. The second body 120 may be connected to the first body 110 so as to be slidable in a vertical direction. A guide rail or the like for guiding the sliding movement of the second body 120 with respect to the first body 110 may be installed between the first body 110 and the second body 120.

The specific shape of the second body 120 is not limited to the shape illustrated in FIG. 2 to FIG. 5, and the design may be changed in various forms connected to the first body 110 so as to be slidable in the vertical direction.

The shock absorber 130 may be disposed between the first body 110 and the second body 120. The shock absorber 130 may function as a component for absorbing vibrations generated during vehicle travel or shocks from bump and rebound movements of the wheel 200.

The shock absorber 130 according to the embodiment may be exemplified as various types of shock absorbing devices including a damper and a spring stretchable in a length direction. The length direction of the shock absorber 130 may be disposed parallel to the sliding movement direction of the second body 120. Both ends of the shock absorber 130 may be connected to the first body 110 and the second body 120, respectively. Accordingly, the shock absorber 130 may absorb an external force due to the sliding movement of the second body 120 by its own damping force and elastic force.

A plurality of shock absorbers 130 may be provided. The length directions of the plurality of shock absorbers 130 may be disposed parallel to each other. The plurality of shock absorbers 130 may be disposed between the first body 110 and the second body 120 to be spaced apart from each other.

The wheel 200 may be exemplified as various types of wheels that are rotatable about a central axis C0. The wheel 200 may be disposed to be spaced apart from the main body 100. The wheel 200 may be connected to the main body 100 by a first link arm 400, which will be described below. A lower end of the wheel 200 is in contact with the ground and may support the vehicle body 1 with respect to the ground.

The wheel 200 is rotated clockwise or counterclockwise about the central axis C0 by a drive unit 300, which will be described below, and may perform a driving operation with respect to the vehicle body 1. In the embodiment, the central axis C0 of the wheel 200 may be disposed in a direction horizontal to the ground (xy Plane in FIG. 2).

The wheel 200 is rotated clockwise or counterclockwise about a steering axis A by a steering unit 600, which will be described below, and may perform a steering operation with respect to the vehicle body 1. In the embodiment, the steering axis A may be disposed in a direction perpendicular to the ground (Z-axis direction in FIG. 2).

The drive unit 300 is connected to the wheel 200 and may provide driving force to the wheel 200. More specifically, the drive unit 300 may rotate the wheel 200 clockwise or counterclockwise about the central axis C0 of the wheel 200 so that the vehicle body 1 may travel on the ground.

The drive unit 300 according to the embodiment may include an in-wheel motor for receiving power from a source such as the vehicle's battery to generate rotational force for driving the wheel 200. A diameter of the drive unit 300 is formed to be smaller than a diameter of the wheel 200, and the drive unit 300 may be disposed inside the wheel 200. An output shaft of the drive unit 300 may be disposed to be coaxial with the central axis C0 of the wheel 200. The output shaft of the drive unit 300 may be connected to the wheel 200 via a wheel bearing (not illustrated) or the like.

The drive unit 300 may further include a brake disc that rotates together with the wheel 200, and a brake caliper that selectively interferes with the rotation of the brake disc to apply or release braking force to the wheel 200. Accordingly, the drive unit 300 may perform a braking function for the wheel 200.

The first link arm 400 may be disposed between the main body 100 and the drive unit 300. Both sides of the first link arm 400 may be connected to the main body 100 and the drive unit 300, respectively. The first link arm 400 may support the drive unit 300 and the wheel 200 with respect to the main body 100 and may function as a component that guides the movement of the wheel 200 generated during travel of the vehicle.

The first link arm 400 according to the embodiment may include a first outer arm 410 and a first inner arm 420.

The first outer arm 410 may form one side of the exterior of the first link arm 400 that is connected to the drive unit 300.

The first outer arm 410 according to the embodiment may include a first outer end 411 and a first outer connecting part 412.

The first outer end 411 is disposed at one end of the first outer arm 410 and may be connected to the drive unit 300. The first outer end 411 may form an exterior of one end of the first outer arm 410 disposed to face the drive unit 300.

The first outer end 411 may be rotatably connected to an upper side of the drive unit 300 about a rotation axis 411a. The rotation axis 411a of the first outer end 411 may be disposed to be inclined with respect to the steering axis A. For example, the rotation axis 411a of the first outer end 411 may be disposed such that an upper end thereof is tilted toward the wheel 200 by a predefined angle.

The first outer connecting part 412 is disposed at the other end of the first outer arm 410 and may support the first inner arm 420. The first outer connecting part 412 may form an exterior of the other end of the first outer arm 410 located on a side opposite the first outer end 411.

The specific shape of the first outer arm 410 is not limited to the shape illustrated in FIG. 2 to FIG. 5, and various design changes are possible within the scope of a shape including the first outer end 411 and the first outer connecting part 412.

The first inner arm 420 may form the other side of the exterior of the first link arm 400 that is connected to the main body 100.

The first inner arm 420 according to the embodiment may include a first inner connecting part 421 and a first inner end 422.

The first inner connecting part 421 is disposed at one end of the first inner arm 420 and may be connected to the first outer connecting part 412. The first inner connecting part 421 may form an exterior of one end of the first inner arm 420 disposed to face the first outer arm 410.

The first inner connecting part 421 may be rotatably connected to the first outer connecting part 412 about a rotation axis 421a.

The rotation axis 421a of the first inner connecting part 421 may be disposed to be inclined with respect to the steering axis A. For example, the rotation axis 411a of the first inner connecting part 421 may be disposed such that a lower end thereof is tilted toward the wheel 200 by a predefined angle.

The rotation axis 421a of the first inner connecting part 421 may be disposed perpendicular to the rotation axis 411a of the first outer end 411. The rotation axis 421a of the first inner connecting part 421 may be disposed to intersect the rotation axis 411a of the first outer end 411.

An intersection point B of the rotation axis 421a of the first inner connecting part 421 and the rotation axis 411a of the first outer end 411 may be disposed on the steering axis A. During travel of the vehicle or steering of the wheel 200, the first outer arm 410 and the first inner arm 420 are rotated relative to the wheel 200 about the rotation axis 421a of the first inner connecting part 421 and the rotation axis 411a of the first outer end 411, thereby performing multi-axis rotation between the wheel 200 and the first link arm 400, that is, a kind of ball joint motion. Accordingly, the corner module 2 according to the embodiment may realize the effect of a virtual ball joint between the wheel 200 and the first link arm 400 being located on the steering axis A through the rotation axis 421a of the first inner connecting part 421 and the rotation axis 411a of the first outer end 411.

The first inner end 422 is disposed at the other end of the first inner arm 420 and may be connected to the main body 100, more specifically, to the second body 120. The first inner end 422 may form an exterior of the other end of the first inner arm 420 disposed to face the second body 120.

The first inner end 422 may be rotatably connected to the second body 120 about a rotation axis 422a. The rotation axis 421a of the first inner connecting part 421 and the rotation axis 422a of the first inner end 422 may be disposed to intersect each other. The rotation axis 411a of the first outer end 411 and the rotation axis 422a of the first inner end 422 may be disposed to intersect each other. The rotation axis 422a of the first inner end 422 may be disposed to be inclined with respect to the steering axis A. In the embodiment, the rotation axis 422a of the first inner end 422 may be disposed perpendicular to the steering axis A and horizontal to the ground.

The specific shape of the first inner arm 420 is not limited to the shape illustrated in FIG. 2 to FIG. 5, and various design changes are possible within the scope of a shape including the first inner connecting part 421 and the first inner end 422.

The steering motor 500 may generate a driving force for a steering operation of the wheel 200.

The steering motor 500 according to the embodiment may receive power from a vehicle's battery or the like to generate rotational force. The steering motor 500 may be exemplified as a hollow shaft motor having a hollow-shaped output shaft.

The steering motor 500 may be disposed inside the first link arm 400. For example, the steering motor 500 may be disposed inside the first inner arm 420. The steering motor 500 may be fixed inside the first inner arm 420 by various types of coupling methods such as welding, bolting, or fitting. Accordingly, the corner module 2 according to the embodiment may reduce the overall size of the product, eliminate various fixing parts due to the external arrangement of the steering motor 500, and prevent the steering motor 500 from interfering with the movement of the first link arm 400.

The steering unit 600 is connected to the steering motor 500 and may adjust a steering angle of the wheel 200 by the driving of the steering motor 500. More specifically, the steering unit 600 may rotate the wheel 200 clockwise or counterclockwise about the steering axis A by the driving of the steering motor 500.

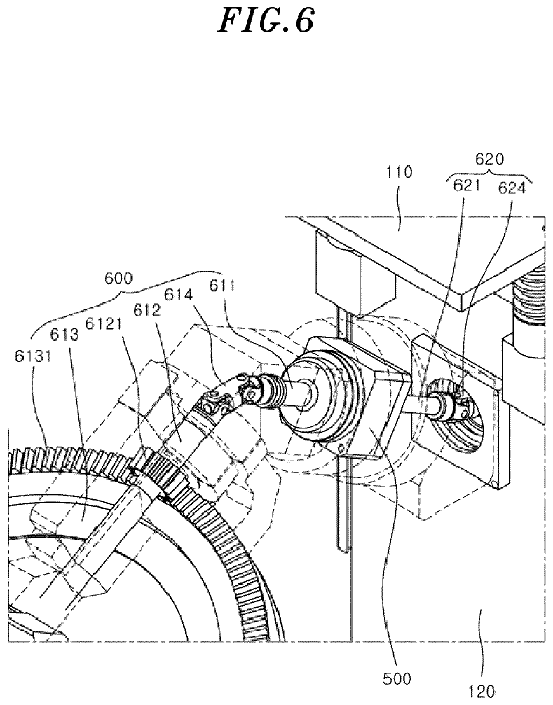

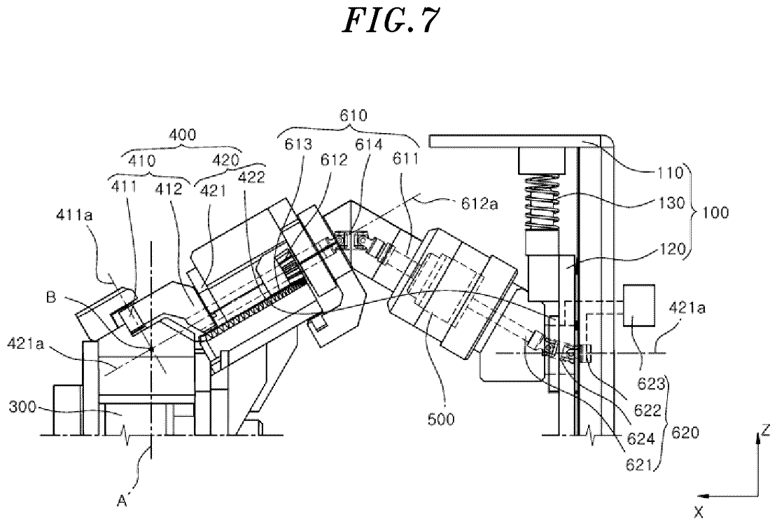

FIG. 6 is a perspective view schematically illustrating a configuration of a steering unit according to an exemplary embodiment, and FIG. 7 is a side view schematically illustrating a configuration of a steering unit according to an exemplary embodiment.

Referring to FIG. 2 to FIG. 7, the steering unit 600 according to the embodiment may include a first steering unit 610 and a second steering unit 620.

The first steering unit 610 may be connected to the steering motor 500 and the drive unit 300. The first steering unit 610 may rotate the drive unit 300 with respect to the first outer arm 410. As the drive unit 300 is integrally connected to the wheel 200, the wheel 200 may be rotated together with the drive unit 300 with respect to the first outer arm 410 during operation of the first steering unit 610.

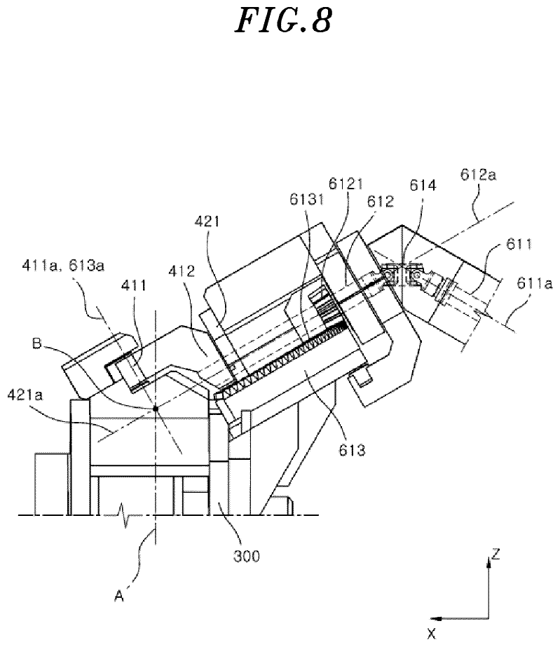

FIG. 8 is an enlarged view schematically illustrating a configuration of a first steering unit according to the embodiment of the present disclosure.

Referring to FIG. 7 and FIG. 8, the first steering unit 610 according to the embodiment of the present disclosure may include a steering shaft 611, a first steering transmission member 612, and a second steering transmission member 613.

The steering shaft 611 is connected to the steering motor 500 and may be rotated by receiving driving force from the steering motor 500.

The steering shaft 611 according to the embodiment may have the shape of a rod rotatable about a rotation axis 611a. The steering shaft 611 may be disposed inside the first link arm 400, more specifically, inside the first inner arm 420.

The steering shaft 611 may be disposed on one side of the steering motor 500 inside the first inner arm 420. For example, the steering shaft 611 may be disposed between the steering motor 500 and the first inner connecting part 421.

The rotation axis 611a of the steering shaft 611 may be disposed coaxially with an output shaft of the steering motor 500. The angle of the rotation axis 611a of the steering shaft 611 is not limited to that illustrated in FIG. 7 and FIG. 8, and may be changed in various designs according to the angle of the steering motor 500.

One end of the steering shaft 611 disposed to face the steering motor 500 may be connected to the output shaft of the steering motor 500. Accordingly, during operation of the steering motor 500, the steering shaft 611 may be rotated clockwise or counterclockwise about the rotation axis 611a.

The first steering transmission member 612 is connected to the steering shaft 611 and may rotate together with the steering shaft 611.

The first steering transmission member 612 according to the embodiment may have the shape of a rod rotatable about a rotation axis 612a. The first steering transmission member 612 may be disposed inside the first link arm 400, more specifically, inside the first inner arm 420. The first steering transmission member 612 may be disposed between the steering shaft 611 and the first inner connecting part 421.

One end of the first steering transmission member 612 disposed to face the steering shaft 611 may be connected to the steering shaft 611. The first steering transmission member 612 may be rotated at the same angular velocity as the steering shaft 611 upon rotation of the steering shaft 611.

In the embodiment, the rotation axis 612a of the first steering transmission member 612 and the rotation axis 611a of the steering shaft 611 may be disposed to intersect each other. To facilitate the smooth transmission of rotational force between the first steering transmission member 612 and the steering shaft 611, which are disposed to intersect each other, an outer universal joint 614 may be placed between them. The outer universal joint 614 may be exemplified as various types of universal joints for mediating the transmission of power between two intersecting rotation axes. Both ends of the outer universal joint 614 may be respectively connected to the other end of the steering shaft 611 and one end of the first steering transmission member 612, which are disposed to face each other. If the rotation axis 612a of the first steering transmission member 612 and the rotation axis 611a of the steering shaft 611 coincide with each other, the outer universal joint 614 may be omitted.

The rotation axis 612a of the first steering transmission member 612 may be disposed coaxially with the rotation axis 421a of the first inner connecting part 421. That is, the rotation axis 612a of the first steering transmission member 612 and the rotation axis 421a of the first inner connecting part 421 may be the same.

The other end of the first steering transmission member 612 disposed to face the first inner connecting part 421 may pass through the first inner connecting part 421 and be inserted into the first outer connecting part 412. Since the rotation axis 612a of the first steering transmission member 612 and the rotation axis 421a of the first inner connecting part 421 are the same, the other end of the first steering transmission member 612 may rotatably support the first inner connecting part 421 with respect to the first outer connecting part 412 about the rotation axis 421a of the first inner connecting part 421.

The first steering transmission member 612 may further include a pinion gear 6121.

The pinion gear 6121 may be formed to have a hollow ring shape. An inner circumferential surface of the pinion gear 6121 may be integrally fixed to an outer circumferential surface of the first steering transmission member 612. Pinion teeth having a predefined pitch and angle may be formed on the outer circumferential surface of the pinion gear 6121. A central axis of the pinion gear 6121 may be located coaxially with the rotation axis 612a of the first steering transmission member 612. Accordingly, upon rotation of the first steering transmission member 612, the pinion gear 6121 may be rotated together with the first steering transmission member 612 clockwise or counterclockwise about the rotation axis 612a of the first steering transmission member 612.

The pinion gear 6121 may be disposed outside the first inner arm 420. For example, a partial area of the first steering transmission member 612 may protrude to the outside of the first inner arm 420, and the pinion gear 6121 may be disposed in the partial area of the first steering transmission member 612 that protrudes to the outside of the first inner arm 420.

The second steering transmission member 613 may be connected to the drive unit 300 and the first steering transmission member 612. The second steering transmission member 613 may receive rotational force from the first steering transmission member 612 to rotate and thereby rotate the drive unit 300. That is, the second steering transmission member 613 may function as a component that finally transmits the rotational force applied from the steering motor 500 to the steering shaft 611 to the drive unit 300, thereby rotating the drive unit 300 and the wheel 200 with respect to the first outer arm 410.

The second steering transmission member 613 according to the embodiment may extend from an inner surface of the drive unit 300 toward the main body 100. The second steering transmission member 613 may have an arc-shaped cross-section with a rotation axis 613a.

The rotation axis 613a of the second steering transmission member 613 may be disposed to be inclined with respect to the steering axis A. For example, the rotation axis 613a of the second steering transmission member 613 may be parallel to the rotation axis 411a of the first outer end 411. Accordingly, in the embodiment, the second steering transmission member 613 may have a shape extending obliquely upward from the inner surface of the drive unit 300.

The rotation axis 613a of the second steering transmission member 613 may be disposed coaxially with the rotation axis 411a of the first outer end 411. That is, the rotation axis 613a of the second steering transmission member 613 and the rotation axis 411a of the first outer end 411 may be the same.

A part of an upper surface of the second steering transmission member 613 may be disposed to face the pinion gear 6121 exposed to the outside of the first inner arm 420.

The second steering transmission member 613 according to the embodiment may include a bevel gear 6131.

The bevel gear 6131 may protrude from the upper surface of the second steering transmission member 613 disposed to face the pinion gear 6121. The bevel gear 6131 may extend along a circumferential direction about the rotation axis 613a of the second steering transmission member 613 on the second steering transmission member 613. Bevel teeth having a predefined pitch and angle may be formed on an upper surface of the bevel gear 6131.

The upper surface of the bevel gear 6131 may be meshed and coupled with the outer circumferential surface of the pinion gear 6121. Upon rotation of the pinion gear 6121, the second steering transmission member 613 may be rotated together with the bevel gear 6131 clockwise or counterclockwise about the rotation axis 613a of the second steering transmission member 613. Accordingly, upon rotation of the second steering transmission member 613 by the first steering transmission member 612, the drive unit 300 and the wheel 200 may rotate together with the second steering transmission member 613 about the rotation axis 411a of the first outer end 411.

The second steering unit 620 may be connected to the steering motor 500 and the first inner arm 420. The second steering unit 620 may rotate the first inner arm 420 with respect to the main body 100. For example, the second steering unit 620 may rotate the first inner arm 420 with respect to the second body 120 about the rotation axis 422a of the first inner end 422.

The second steering unit 620 may function as a component that adjusts the position and angle of the first link arm 400 during the steering process of the wheel 200 to prevent interference between the wheel 200 and the first link arm 400 and to expand the steerable range of the wheel 200.

In the embodiment, the first steering unit 610 rotates the drive unit 300 about the rotation axis 411a of the first outer end 411, which is inclined with respect to the steering axis A, and the second steering unit 620 may rotate the first link arm 400 about the rotation axis 422a of the first inner end 422, which is inclined with respect to the steering axis A and the rotation axis 411a of the first outer end 411. Accordingly, the wheel 200 may rotate about the steering axis A by the combination of the rotational motion of the drive unit 300 about the rotation axis 411a of the first outer end 411 and the rotational motion of the first link arm 400 about the rotation axis 422a of the first inner end 422.

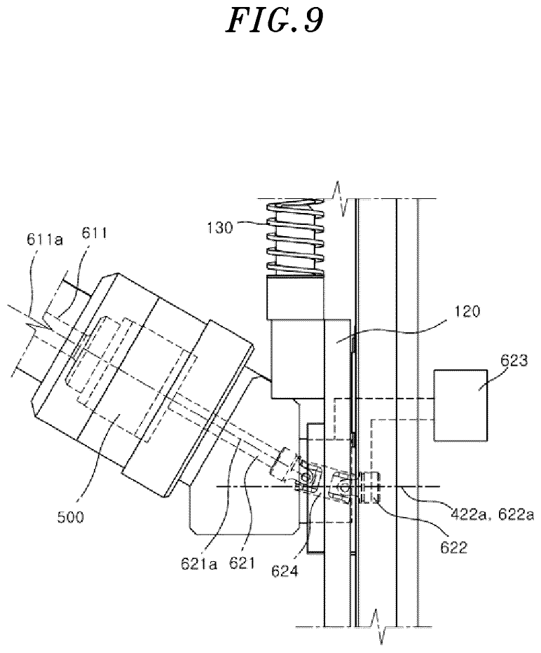

FIG. 9 is an enlarged view schematically illustrating a configuration of a second steering unit according to the embodiment of the present disclosure.

Referring to FIG. 9, the second steering unit 620 according to the embodiment may include an arm shaft 621, a first arm transmission member 622, and a second arm transmission member 623.

The arm shaft 621 is connected to the steering motor 500 and may be rotated by receiving driving force from the steering motor 500.

The arm shaft 621 according to the embodiment may have the shape of a rod rotatable about a rotation axis 621a. The arm shaft 621 may be disposed inside the first link arm 400, more specifically, inside the first inner arm 420.

The arm shaft 621 may be disposed on the other side of the steering motor 500 inside the first inner arm 420. For example, the arm shaft 621 may be disposed between the steering motor 500 and the first inner end 422.

The rotation axis 621a of the arm shaft 621 may be disposed coaxially with the output shaft of the steering motor 500. The rotation axis 621a of the arm shaft 621 and the rotation axis 611a of the steering shaft 611 may be disposed coaxially. The rotation axis 621a of the arm shaft 621 and the rotation axis 611a of the steering shaft 611 may be the same.

One end of the arm shaft 621 disposed to face the steering motor 500 may be connected to the output shaft of the steering motor 500. Accordingly, during operation of the steering motor 500, the arm shaft 621 may be rotated clockwise or counterclockwise about the rotation axis 621a.

The steering shaft 611 and the arm shaft 621 may be disposed on opposite sides with respect to the steering motor 500. For example, the steering shaft 611 and the arm shaft 621 may extend in opposite directions from the steering motor 500.

The first arm transmission member 622 is connected to the arm shaft 621 and may rotate together with the arm shaft 621.

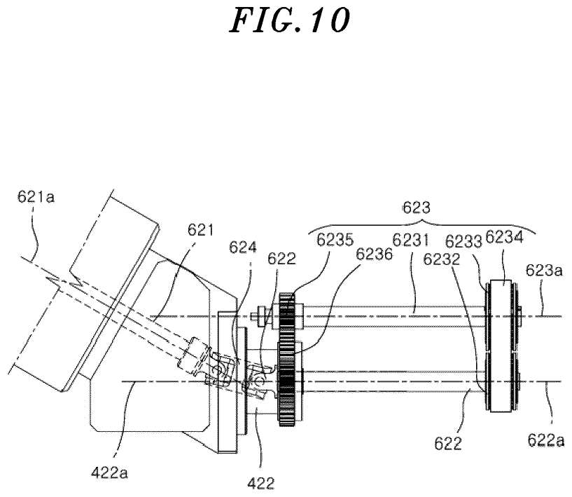

FIG. 10 is a side view schematically illustrating a configuration of a first arm transmission member and a second arm transmission member according to the embodiment of the present disclosure.

Referring to FIG. 10, the first arm transmission member 622 according to the embodiment may have the shape of a rod rotatable about a rotation axis 622a. One end of the first arm transmission member 622 disposed to face the arm shaft 621 may be disposed inside the first inner arm 420, more specifically, inside the first inner end 422.

One end of the first arm transmission member 622 disposed to face the arm shaft 621 may be connected to the arm shaft 621. The first arm transmission member 622 may be rotated at the same angular velocity as the arm shaft 621 upon rotation of the arm shaft 621.

In the embodiment, the rotation axis 622a of the first arm transmission member 622 and the rotation axis 621a of the arm shaft 621 may be disposed to intersect each other. To facilitate the smooth transmission of rotational force between the first arm transmission member 622 and the arm shaft 621, which are disposed to intersect each other, an inner universal joint 624 may be placed between them. The inner universal joint 624 may be exemplified as various types of universal joints for mediating the transmission of power between two intersecting rotation axes. Both ends of the inner universal joint 624 may be respectively connected to the other end of the arm shaft 621 and one end of the first arm transmission member 622, which are disposed to face each other. If the rotation axis 622a of the first arm transmission member 622 and the rotation axis 621a of the arm shaft 621 coincide with each other, the inner universal joint 624 may be omitted.

The rotation axis 622a of the first arm transmission member 622 may be parallel to the rotation axis 422a of the first inner end 422. In the embodiment, the rotation axis 622a of the first arm transmission member 622 may be disposed coaxially with the rotation axis 422a of the first inner end 422. That is, the rotation axis 622a of the first arm transmission member 622 and the rotation axis 422a of the first inner end 422 may be the same.

The other end of the first arm transmission member 622 located on a side opposite the arm shaft 621 may pass through the first inner end 422. The other end of the first arm transmission member 622 may be disposed inside the main body 100, and alternatively, it may be disposed outside the main body 100.

The second arm transmission member 623 may be connected to the first arm transmission member 622 and the first inner end 422. The second arm transmission member 623 may rotate the first inner end 422 in conjunction with the rotation of the first arm transmission member 622.

The second arm transmission member 623 may rotate the first inner end 422 in a direction opposite to the first arm transmission member 622. Accordingly, the second arm transmission member 623 may cause the first link arm 400 to be rotated to a position that does not interfere with the rotation path of the wheel 200 about the steering axis A during operation of the steering motor 500. The second arm transmission member 623 may be disposed inside the main body 100, and alternatively, it may be disposed outside the main body 100.

In one embodiment, the second arm transmission member 623 may include an arm transmission shaft 6231, a first pulley 6232, a second pulley 6233, a belt 6234, a first gear 6235, and a second gear 6236.

The arm transmission shaft 6231 may be spaced apart from the first arm transmission member 622. The arm transmission shaft 6231 may be disposed outside the first inner end 422. The arm transmission shaft 6231 may have the shape of a rod rotatable about a rotation axis 623a. The rotation axis 623a of the arm transmission shaft 6231 may be spaced apart from the rotation axis 622a of the first arm transmission member 622. The rotation axis 623a of the arm transmission shaft 6231 may be disposed parallel to the rotation axis 622a of the first arm transmission member 622.

The first pulley 6232 may be connected to the first arm transmission member 622. The first pulley 6232 may be disposed at the other end of the first arm transmission member 622 that has passed through the first inner end 422. A central axis of the first pulley 6232 may be disposed coaxially with the rotation axis 622a of the first arm transmission member 622. An inner circumferential surface of the first pulley 6232 may be fixed to an outer circumferential surface of the first arm transmission member 622. Accordingly, the first pulley 6232 may rotate together with the first arm transmission member 622 about the rotation axis 622a of the first arm transmission member 622 upon rotation of the first arm transmission member 622.

The second pulley 6233 may be connected to the arm transmission shaft 6231. The second pulley 6233 may be disposed at one end of the arm transmission shaft 6231 that faces the first pulley 6232. A central axis of the second pulley 6233 may be disposed coaxially with the rotation axis 623a of the arm transmission shaft 6231. An inner circumferential surface of the second pulley 6233 may be fixed to an outer circumferential surface of the arm transmission shaft 6231. An outer circumferential surface of the second pulley 6233 may be disposed to face the outer circumferential surface of the first pulley 6232.

The belt 6234 may convert the rotational motion of the first pulley 6232 into the rotational motion of the second pulley 6233. The belt 6234 may have the shape of a closed loop disposed to wrap around the outer circumferential surfaces of the first pulley 6232 and the second pulley 6233. An inner circumferential surface of the belt 6234 may be in frictional contact with the outer circumferential surfaces of the first pulley 6232 and the second pulley 6233.

Upon rotation of the first pulley 6232, the belt 6234 may circulate around the circumferences of the first pulley 6232 and the second pulley 6233 in a continuous track manner along a closed-loop path. During the movement of the belt 6234, the second pulley 6233 rotates about the rotation axis 623a of the arm transmission shaft 6231 due to frictional force with the belt 6234, and the arm transmission shaft 6231 may rotate together with the second pulley 6233 about the rotation axis 623a of the arm transmission shaft 6231. The rotation direction of the second pulley 6233 and the arm transmission shaft 6231 may be the same as the rotation direction of the first pulley 6232 and the first arm transmission member 622.

The first gear 6235 may be connected to the arm transmission shaft 6231. The first gear 6235 may be disposed at the other end of the arm transmission shaft 6231 located on a side opposite the second pulley 6233. A central axis of the first gear 6235 may be disposed coaxially with the rotation axis 623a of the arm transmission shaft 6231. An inner circumferential surface of the first gear 6235 may be fixed to an outer circumferential surface of the arm transmission shaft 6231. Accordingly, the first gear 6235 may rotate together with the arm transmission shaft 6231 about the rotation axis 623a of the arm transmission shaft 6231 upon rotation of the arm transmission shaft 6231. Gear teeth such as spur gear teeth or helical gear teeth may be formed on an outer circumferential surface of the first gear 6235.

The second gear 6236 may be connected to the first inner end 422. The second gear 6236 may be disposed on an outer circumferential surface of the first inner end 422 that faces the first gear 6235. A central axis of the second gear 6236 may be disposed coaxially with the rotation axis 422a of the first inner end 422. An inner circumferential surface of the second gear 6236 may be fixed to the outer circumferential surface of the first inner end 422. Gear teeth such as spur gear teeth or helical gear teeth may be formed on an outer circumferential surface of the second gear 6236.

The outer circumferential surface of the second gear 6236 may be meshed and coupled with the outer circumferential surface of the first gear 6235. Accordingly, upon rotation of the first gear 6235, the second gear 6236 rotates about the rotation axis 422a of the first inner end 422, and the first inner end 422 may rotate together with the second gear 6236 about the rotation axis 422a of the first inner end 422. The rotation direction of the second gear 6236 and the first inner end 422 may be opposite to the rotation direction of the second pulley 6233 and the arm transmission shaft 6231, and the rotation direction of the first pulley 6232 and the first arm transmission member 622.

The second arm transmission member 623 is not limited to the above configuration and may have various types of power transmission structures capable of rotating the first inner end 422 in a direction opposite to the first arm transmission member 622.

The corner module 2 according to the embodiment may further include a second link arm 700.

The second link arm 700 may be disposed between the main body 100 and the drive unit 300. Both sides of the second link arm 700 may be connected to the main body 100 and the drive unit 300, respectively. The second link arm 700, together with the first link arm 400, may support the drive unit 300 and the wheel 200 with respect to the main body 100 and may function as a component that guides the movement of the wheel 200 generated during travel of the vehicle.

The second link arm 700 may be spaced apart from the first link arm 400. In the embodiment, the second link arm 700 may be disposed on a lower side of the first link arm 400. However, the present embodiment is not limited thereto, and it is also possible for the first link arm 400 to be disposed on a lower side of the second link arm 700.

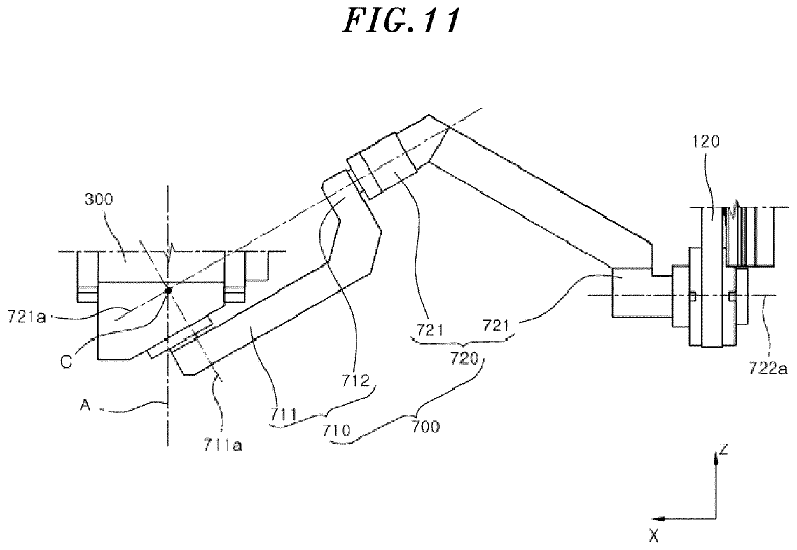

FIG. 11 is an enlarged view schematically illustrating a configuration of the second link arm 700 according to the embodiment of the present disclosure.

The second link arm 700 according to the embodiment may include a second outer arm 710 and a second inner arm 720.

The second outer arm 710 may form one side of the exterior of the second link arm 700 that is connected to the drive unit 300.

The second outer arm 710 according to the embodiment may include a second outer end 711 and a second outer connecting part 712.

The second outer end 711 is disposed at one end of the second outer arm 710 and may be connected to the drive unit 300. The second outer end 711 may form an exterior of one end of the second outer arm 710 disposed to face the drive unit 300.

The second outer end 711 may be rotatably connected to a lower side of the drive unit 300 about a rotation axis 711a. The rotation axis 711a of the second outer end 711 may be disposed to be inclined with respect to the steering axis A. For example, the rotation axis 711a of the second outer end 711 may be disposed such that an upper end thereof is tilted toward the wheel 200 by a predefined angle.

The rotation axis 711a of the second outer end 711 may be disposed parallel to the rotation axis 411a of the first outer end 411.

The second outer connecting part 712 is disposed at the other end of the second outer arm 710 and may support the second inner arm 720. The second outer connecting part 712 may form an exterior of the other end of the second outer arm 710 located on a side opposite the second outer end 711.

The specific shape of the second outer arm 710 is not limited to the shape illustrated in FIG. 11, and various design changes are possible within the scope of a shape including the second outer end 711 and the second outer connecting part 712.

The second inner arm 720 may form the other side of the exterior of the second link arm 700 that is connected to the main body 100.

The second inner arm 720 according to the embodiment may include a second inner connecting part 721 and a second inner end 722.

The second inner connecting part 721 is disposed at one end of the second inner arm 720 and may be connected to the second outer connecting part 712. The second inner connecting part 721 may form an exterior of one end of the second inner arm 720 disposed to face the second outer arm 710.

The second inner connecting part 721 may be rotatably connected to the second outer connecting part 712 about a rotation axis 721a.

The rotation axis 721a of the second inner connecting part 721 may be disposed to be inclined with respect to the steering axis A. For example, the rotation axis 721a of the second inner connecting part 721 may be disposed such that a lower end thereof is tilted toward the wheel 200 by a predefined angle.

The rotation axis 721a of the second inner connecting part 721 may be disposed perpendicular to the rotation axis 711a of the second outer end 711. The rotation axis 721a of the second inner connecting part 721 may be disposed to intersect the rotation axis 711a of the second outer end 711.

The rotation axis 721a of the second inner connecting part 721 may be parallel to the rotation axis 421a of the first inner connecting part 421.

An intersection point C of the rotation axis 721a of the second inner connecting part 721 and the rotation axis 711a of the second outer end 711 may be disposed on the steering axis A. The intersection point C of the rotation axis 721a of the second inner connecting part 721 and the rotation axis 711a of the second outer end 711 may be disposed below the intersection point B of the rotation axis 421a of the first inner connecting part 421 and the rotation axis 411a of the first outer end 411.

During travel of the vehicle or steering of the wheel 200, the second outer arm 710 and the second inner arm 720 are rotated relative to the wheel 200 about the rotation axis 721a of the second inner connecting part 721 and the rotation axis 711a of the second outer end 711, thereby performing multi-axis rotation between the wheel 200 and the second link arm 700, that is, a kind of ball joint motion. Accordingly, the corner module 2 according to the present embodiment may realize the effect of a virtual ball joint between the wheel 200 and the second link arm 700 being located on the steering axis A through the rotation axis 721a of the second inner connecting part 721 and the rotation axis 711a of the second outer end 711.

The second inner end 722 is disposed at the other end of the second inner arm 720 and may be connected to the main body 100, more specifically, to the second body 120. The second inner end 722 may form an exterior of the other end of the second inner arm 720 disposed to face the second body 120.

The second inner end 722 may be rotatably connected to the second body 120 about a rotation axis 722a. The rotation axis 722a of the second inner end 722 may be disposed to be inclined with respect to the steering axis A. The rotation axis 721a of the second inner connecting part 721 and the rotation axis 722a of the second inner end 722 may be disposed to intersect each other. The rotation axis 711a of the second outer end 711 and the rotation axis 722a of the second inner end 722 may be disposed to intersect each other. The rotation axis 722a of the second inner end 722 and the rotation axis 422a of the first inner end 422 may be parallel to each other. In the embodiment, the rotation axis 722a of the second inner end 722 may be disposed perpendicular to the steering axis A and horizontal to the ground.

The specific shape of the second inner arm 720 is not limited to the shape illustrated in FIG. 11, and various design changes are possible within the scope of a shape including the second inner connecting part 721 and the second inner end 722.

During steering of the wheel 200 by the steering unit 600, the second inner arm 720 may be rotated relative to the main body 100 about the rotation axis 722a of the second inner end 722 by a reaction force applied from the wheel 200. The rotation angle and rotation direction of the second inner arm 720 may be the same as the rotation angle and rotation direction of the first inner arm 420 by the second steering unit 620.

Hereinafter, the operation of the corner module 2 according to the embodiment of the present disclosure will be described.

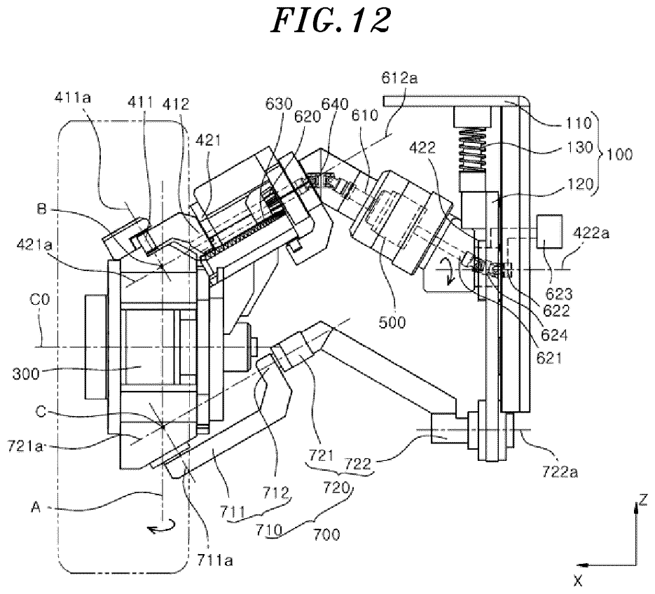

FIG. 12 to FIG. 15 are diagrams schematically illustrating an operating state of the corner module device according to the embodiment of the present disclosure.

Referring to FIG. 1 to FIG. 15, during travel of the vehicle, the drive unit 300 may generate rotational force based on a driver's pedal input.

The wheel 200 rotates about the central axis C0 by the rotational force transmitted from the drive unit 300, and the vehicle may move forward or backward on the ground.

During a steering operation of the vehicle, the steering motor 500 may generate rotational force based on a driver's operation of a steering wheel.

The rotational force generated from the steering motor 500 is transmitted to the first steering unit 610 and the second steering unit 620, respectively, and may rotate the wheel 200 about the steering axis A.

More specifically, the rotational force transmitted to the first steering unit 610 may be transmitted to the drive unit 300 sequentially through the steering shaft 611, the first steering transmission member 612, the pinion gear 6121, the bevel gear 6131, and the second steering transmission member 613.

The drive unit 300 may rotate relative to the first outer arm 410 about the rotation axis 411a of the first outer end 411 by the rotational force transmitted from the first steering unit 610.

The rotational force transmitted to the second steering unit 620 may be transmitted to the first inner arm 420 sequentially through the arm shaft 621, the first arm transmission member 622, and the second arm transmission member 623.

The first inner arm 420 may rotate relative to the main body 100 about the rotation axis 422a of the first inner end 422.

The wheel 200 may rotate about the steering axis A by the combined action of the rotational motion of the drive unit 300 by the first steering unit 610 and the rotational motion of the first inner arm 420 by the second steering unit 620, thereby varying the steering angle of the vehicle.

During the steering process of the wheel 200, the second steering unit 620 may rotate the first inner arm 420 so that the first link arm 400 does not interfere with the steering rotation path of the wheel 200.

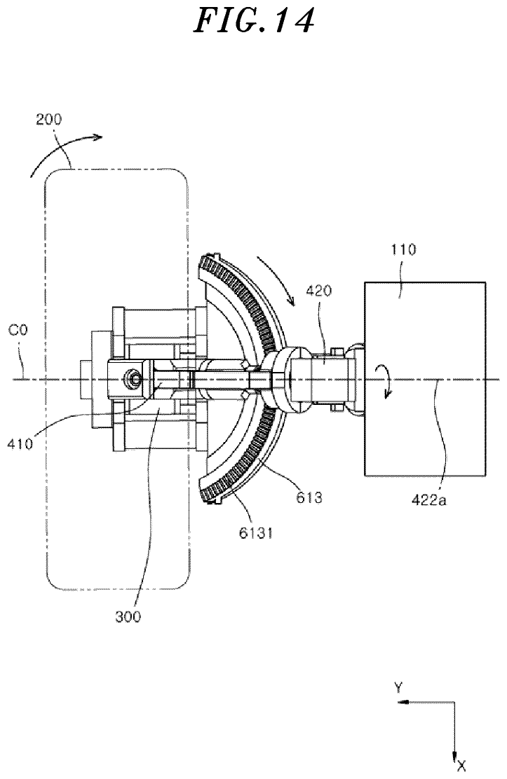

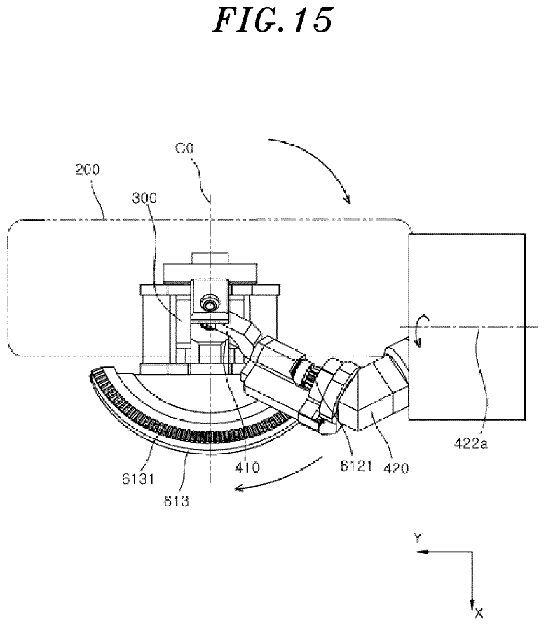

For example, when the wheel 200 rotates clockwise about the steering axis A with reference to FIG. 14 and FIG. 15, the second steering unit 620 may rotate the first inner arm 420 clockwise about the rotation axis 422a of the first inner end 422.

Conversely, when the wheel 200 rotates counterclockwise about the steering axis A, the second steering unit 620 may rotate the first inner arm 420 counterclockwise about the rotation axis 422a of the first inner end 422.

During the steering process of the wheel 200, the second link arm 700 may be rotated by the reaction force according to the steering operation of the wheel 200 so as not to interfere with the steering rotation path of the wheel 200.

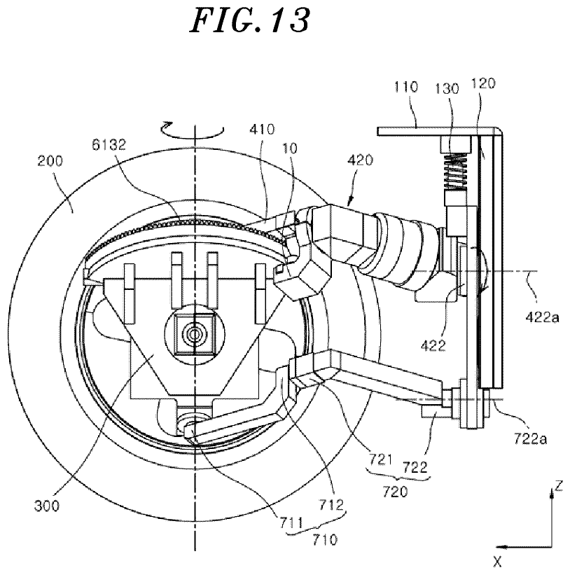

For example, when the wheel 200 rotates clockwise about the steering axis A with reference to FIG. 14 and FIG. 15, the second inner arm 720 may be rotated clockwise about the rotation axis 722a of the second inner end 722 as illustrated in FIG. 13.

Conversely, when the wheel 200 rotates counterclockwise about the steering axis A, the second inner arm 720 may be rotated counterclockwise about the rotation axis 722a of the second inner end 722 as illustrated in FIG. 13.

Although the present disclosure has been described with reference to the embodiments illustrated in the drawings, these are merely exemplary, and it will be understood by those skilled in the art that various modifications and other equivalent embodiments are possible therefrom.

Therefore, the true technical scope of protection hereof should be determined by the appended claims.

### DESCRIPTION OF REFERENCE NUMERALS

1: vehicle body
2: corner module
100: main body
110: first body
120: second body
130: shock absorber
200: wheel
300: drive unit
400: first link arm
410: first outer arm
411: first outer end
412: first outer connecting part
420: first inner arm
421: first inner connecting part
422: first inner end
500: steering motor
600: steering unit
610: first steering unit
611: steering shaft
612: first steering transmission member
6121: pinion gear
613: second steering transmission member
6131: bevel gear
614: outer universal joint
620: second steering unit
621: arm shaft
622: first arm transmission member
623: second arm transmission member
6231: arm transmission shaft
6232: first pulley
6233: second pulley
6234: belt
6235: first gear
6236: second gear
700: second link arm
710: second outer arm
711: second outer end
712: second outer connecting part
720: second inner arm
721: second inner connecting part
722: second inner end
A: steering axis

What is claimed is:

1. A corner module, comprising:
a main body;
a wheel spaced apart from the main body;
a drive unit connected to the wheel and configured to provide a driving force to the wheel;
a first link arm disposed between the main body and the drive unit;
a steering motor disposed inside the first link arm; and
a steering unit connected to the steering motor and configured to rotate the wheel about a steering axis.

2. The corner module of claim 1, wherein the first link arm comprises:
a first outer arm having a first outer end rotatably connected to the drive unit and a first outer connecting part spaced apart from the first outer end; and
a first inner arm having a first inner connecting part rotatably connected to the first outer connecting part and a first inner end rotatably connected to the main body,
wherein the steering motor is disposed inside the first inner arm.

3. The corner module of claim 2, wherein a rotation axis of the first outer end is disposed to be inclined with respect to the steering axis.

4. The corner module of claim 2, wherein a rotation axis of the first inner connecting part intersects a rotation axis of the first outer end, and
an intersection point of the rotation axis of the first outer end and the rotation axis of the first inner connecting part is disposed on the steering axis.

5. The corner module of claim 2, wherein the steering unit comprises:
a first steering unit connected to the steering motor and the drive unit and configured to rotate the drive unit with respect to the first outer arm; and
a second steering unit connected to the steering motor and the first inner arm and configured to rotate the first inner arm with respect to the main body.

6. The corner module of claim 5, wherein the first steering unit comprises:
a steering shaft connected to the steering motor;
a first steering transmission member connected to the steering shaft and rotating together with the steering shaft; and
a second steering transmission member connected to the drive unit and the first steering transmission member, wherein the second steering transmission member receives rotational force from the first steering transmission member and is rotated to rotate the drive unit.

7. The corner module of claim 6, wherein a rotation axis of the steering shaft and a rotation axis of the first steering transmission member are disposed to intersect each other, and
the first steering unit further comprises an outer universal joint disposed between the steering shaft and the first steering transmission member.

8. The corner module of claim 6, wherein a rotation axis of the second steering transmission member is disposed to be inclined with respect to the steering axis.

9. The corner module of claim 6, wherein a rotation axis of the second steering transmission member is parallel to a rotation axis of the first outer end.

10. The corner module of claim 6, wherein a rotation axis of the first steering transmission member and a rotation axis of the second steering transmission member are disposed to intersect each other.

11. The corner module of claim 10, wherein the second steering transmission member includes a bevel gear.

12. The corner module of claim 6, wherein the second steering unit comprises:
an arm shaft connected to the steering motor;
a first arm transmission member connected to the arm shaft and rotating together with the arm shaft; and
a second arm transmission member connected to the first arm transmission member and the first inner end, wherein the second arm transmission member rotates in association with rotation of the first arm transmission member and rotates the first inner end portion.

13. The corner module of claim 12, wherein a rotation axis of the arm shaft and a rotation axis of the first arm transmission member are disposed to intersect each other, and
the second steering unit further includes an inner universal joint disposed between the arm shaft and the first arm transmission member.

14. The corner module of claim 12, wherein a rotation axis of the first arm transmission member is parallel to a rotation axis of the first inner end, and
the first inner end rotates in a direction opposite to the first arm transmission member.

15. The corner module of claim 12, wherein a rotation axis of the steering shaft and a rotation axis of the arm shaft are disposed coaxially, and the steering shaft and the arm shaft extend in opposite directions from the steering motor.

16. The corner module of claim 2, further comprising:
a second link arm disposed between the main body and the drive unit, and spaced apart from the first link arm,
wherein the second link arm comprises:
a second outer arm having a second outer end rotatably connected to the drive unit and a second outer connecting part spaced apart from the second outer end; and
a second inner arm having a second inner connecting part rotatably connected to the second outer connecting part and a second inner end connected to the main body.

17. The corner module of claim 16, wherein an intersection point of a rotation axis of the second outer end and a rotation axis of the second inner connecting part is disposed on the steering axis.

18. The corner module of claim 16, wherein a rotation axis of the first inner end and a rotation axis of the second inner end are parallel to each other.

19. The corner module of claim 1, wherein the main body comprises:
a first body;
a second body movably connected to the first body and supporting the first link arm; and
a shock absorber disposed between the first body and the second body.

20. A vehicle, comprising:
a vehicle body; and
a plurality of corner modules disposed on a lower side of the vehicle body,
wherein the corner module comprises:
a main body connected to the vehicle body;
a wheel spaced apart from the main body;
a drive unit connected to the wheel and configured to provide a driving force to the wheel;
a first link arm disposed between the main body and the drive unit;
a steering motor disposed inside the first link arm; and
a steering unit connected to the steering motor and the drive unit and configured to rotate the wheel about a steering axis.
